(19) United States
(12) Patent Application Publication
(10) Pub. No.: US 2007/0242960 A1
(43) Pub. Date: Oct. 18, 2007

(54) IMAGE FORMING APPARATUS

(75) Inventor: Hidenori Kobayashi, Sunto-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/736,077

(22) Filed: Apr. 17, 2007

(30) Foreign Application Priority Data
Apr. 17, 2006 (JP) 2006-113340
Mar. 26, 2007 (JP) 2007-79205

(51) Int. Cl. G03G 15/00

(52) U.S. Cl. 399/13; 399/88

(57) ABSTRACT

An image forming apparatus comprises a housing, a unit removably provided in the housing and configured to perform a specific operation in cooperation with components provided in the housing while being provided in the housing, an accessory circuit included in the unit, a cover that covers the unit provided in the housing, a first detector that detects a state in which the unit is set in the housing, a second detector that detects whether the cover is opened or closed, and a control section for controlling the supply of power to the unit in accordance with the results of detection made by the first and second detectors. The control section applies an operating voltage to the entire unit while the unit remains set in the housing and the cover remains closed, applies the operating voltage to the accessory circuit while the cover remains opened, and stops the application of the operating voltage to the entire unit when the unit is removed from the housing.

### CROSS-REFERENCE TO RELATED APPLICATION

This application is based upon and claims the benefit of priority from the prior Japanese Patent Application No. 2006-113340, filed on Apr. 17, 2006, and Japanese Patent Application No. 2007-79205, filed on Mar. 26, 2007, the entire contents of which are incorporated herein by reference.

### BACKGROUND OF THE INVENTION

1. Field of the Invention

The present invention relates to an image forming apparatus such as a multi-function peripherals (MFP), a copier or a printer. More particularly, the invention relates to an image forming apparatus in which power can be appropriately supplied to the exchangeable units.

2. Description of the Related Art

In most image forming apparatuses such as MFPs, copiers and printers, the exchangeable units are removably provided in the housing. When the components of any exchangeable unit get dirty or damaged, the unit is removed from the housing for maintenance or for exchange with a new one.

Among such exchangeable units is, for example, a fixing equipment. Any image forming apparatus has the fixing equipment, which fixes the toner image formed on a paper sheet. The fixing equipment has, for example, a heat roller and a pressure roller. A paper sheet is transported through a nip between these paired rollers.

The fixing equipment is a removable unit that is provided in the housing of the image forming apparatus. To remove the fixing equipment from the housing of the image forming apparatus, the cover on the housing is opened. For safety, the supply of power to this unit must be stopped as long as the cover remains open.

The unit may incorporate accessory circuits such as a sheet sensor, in addition to the drive circuit for rotating the fixing roller. The accessory circuits, including the sheet sensor, inevitably stop operating as the supply of power to them is stopped when the cover is opened. While the cover remains open, there may be signals that the accessory circuits must detect. In this case, the signals cannot be detected at all. Hence, the unit can be removed from, or inserted into, the housing, only while the power switch to the image forming apparatus remains off.

While the cover remains open, the sheet sensor provided in the unit cannot detect a sheet jamming, if any, occurring in the fixing equipment. The paper sheets may be charred with the heat emanating from the rollers, raising a safety problem. Further, if the unit is removed from, or inserted into, the housing, while the power switch to the apparatus remains off, the temperature of any unit that is much heated, such as the fixing equipment, cannot be detected unless we touch it with hand. This also raises a safety problem.

Jpn. Pat. Appln. Laid-Open Publication No. 2001-265154 discloses an image forming apparatus. This apparatus has a door sensor and a jam sensor. These sensors cooperate, stopping the supply of power to the driving components of the fixing equipment when the door is opened while a jamming is taking place. The image forming apparatus disclosed in this publication has a switch that can drive a motor in the forward direction and stop the motor even while no power is being supplied to the driving components of the fixing equipment. Thus, the user may operate this switch to drive the motor, thereby to eliminate the jamming.

However, the publication discloses nothing about the supply of power to a sheet sensor or the like at the time the cover is opened. Therefore, when the cover is open so that the fixing equipment may be removed from, or inserted into, the housing of the image forming apparatus, the accessory circuits provided in the fixing equipment will stop operating. Inevitably, as long as the cover stays open, the accessory circuits cannot detect signals that constitute necessary information.

The present invention provides an image forming apparatus in which power is supplied to the accessory circuits even while the cover remains open, thereby obtaining necessary information, and which can yet ensure safety.

### BRIEF DESCRIPTION OF THE DRAWINGS

FIG. 1 is a configuration view showing the entire structure of an image forming apparatus according to an embodiment of the present invention;

FIG. 2 is a configuration view showing schematic configuration of a fixing equipment used in the image forming apparatus according to the embodiment of the present invention;

FIG. 3 is a schematic configuration view showing a relationship between a housing and the fixing equipment, provided in the image forming apparatus according to the embodiment of the present invention;

FIG. 4 is a block diagram showing the power supply circuit provided in the image forming apparatus according to the embodiment of the present invention; and

FIG. 5 is a circuit diagram showing the power supply control circuit provided in the image forming apparatus according to the embodiment of the present invention.

### DETAILED DESCRIPTION OF THE PREFERRED EMBODIMENTS

Throughout this description, the embodiments and examples shown should be considered as exemplars, rather than limitations on the apparatus of the present invention.

An embodiment of the present invention will be described in detail, with reference to the accompanying drawings. In each drawing, the components identical to those shown in any other drawing are designated by the same reference numbers.

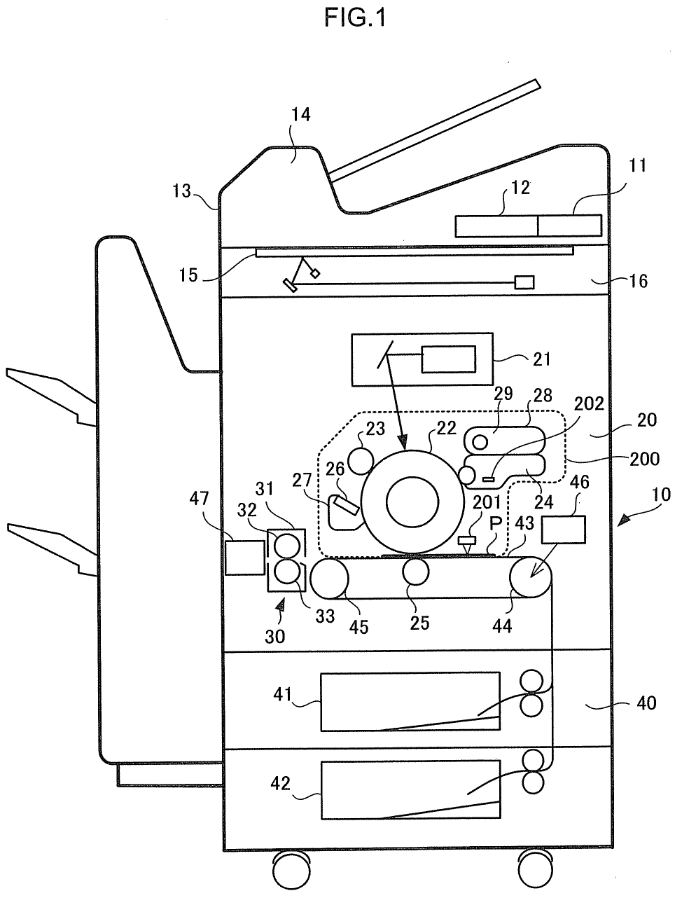

FIG. 1 is a configuration view showing the entire structure of an image forming apparatus according to an embodiment of the present invention. As will be described, the embodiment is a multi-function peripheral (MFP). Nonetheless, this invention can be applied to any other type of an image forming apparatus, such as a printer or a copier.

As FIG. 1 shows, the image forming apparatus 10 has a printer section 20, i.e., image forming section, in the center portion of the image forming apparatus 10. The apparatus 10 further has an operating section 11, a display section 12, and a scanner section 13, which are provided in the upper portion of the housing. The scanner section 13 includes an automatic document feeder (ADF) 14, a transparent document table 15, and an optical system 16. The image forming apparatus 10 has a paper-feed section 40, which is arranged in the lower portion of the apparatus 10.

The printer section 20 composes the image forming section is, for example, a laser printer that performs electro-photographic imaging. The printer section 20 is provided with an exposure equipment 21. The exposure equipment 21 emits a laser beam. The laser beam is applied to a photosensitive drum 22, thus scanning the photosensitive drum 22.

A charger 23, a developing equipment 24, a transfer equipment 25, a cleaner 26, and a toner recovery section 27 are arranged around the photosensitive drum 22. Toner is supplied to the developing equipment 24 from a toner cartridge 28. The toner cartridge 28 has a screw 29 that can rotate to feed supply the toner. If the printer section 20 is a color laser printer, it has four developing equipments that use black toner, cyan toner, magenta toner and yellow toner, respectively.

The charger 23 uniformly charges the surface of the photosensitive drum 22. When the surface of the photosensitive drum 22 is illuminated with the laser beam applied from the exposure equipment 21, an electrostatic latent image is formed. The developing equipment 24 develops the electrostatic latent image, forming a toner image on the photosensitive drum 22.

The paper-feed section 40 comprises a plurality of paper-feed cassettes 41 and 42 that hold paper sheets of different sizes. Paper sheets P can be fed from the paper-feed cassettes 41 and 42 to the transfer equipment 25 by a transport belt 43. The transport belt 43 is an endless belt that is driven as rollers 44 and 45 are rotated. As the transport belt 43 is so driven, a paper sheet P is transported. A transport motor 46 is provided to rotate the rollers 44 and 45.

The transfer equipment 25 transfers the toner image from the photosensitive drum 22 to the paper sheet P. The transport belt 43 transports the paper sheet P to a fixing equipment 30. The fixing equipment 30 includes a unit 31 and a heat roller 32 and a pressure roller 33. Both rollers 32 and 33 are incorporated in the unit 31. The heat roller 32 and the pressure roller 33 cooperate to fix the toner image on the paper sheet P. After passing through the fixing equipment 30, the paper sheet P is ejected from a sheet ejecting unit 47 provided in the image forming apparatus 10. A finisher may be provided on the output side of the image forming apparatus 10. In this case, the finisher may staple or punch the paper sheet P coming from the fixing equipment 30. The paper sheet P is ejected from the finisher.

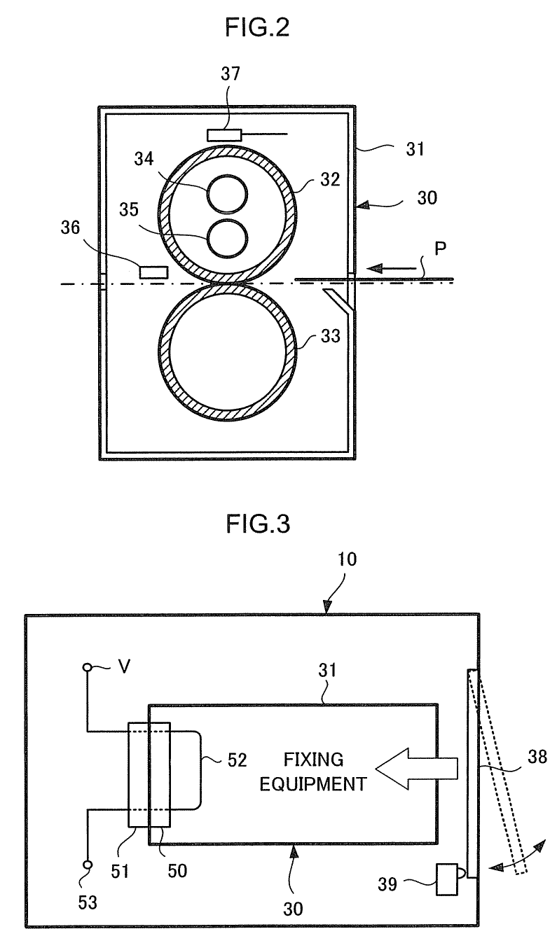

FIG. 2 is a schematic view showing an example of the fixing equipment 30. As shown in FIG. 2, the fixing equipment 30 is composed of a unit 31, a heat roller 32, and a pressure roller 33. The rollers 32 and 33 are provided in the unit 31. The heat roller 32 and the pressure roller 33 are shaped like a hollow cylinder. The heat roller 32 and the pressure roller 33 contact each other, clamping the paper sheet P between them. They feed the paper sheet P forward as they rotate. Halogen lamps 34 and 35 are arranged in the heat roller 32 and used as heat sources.

The halogen lamp 34 has heaters, which heat the end parts (spaced apart in the axial direction) of the heart roller 32. The halogen lamp 35 has a heater, which heats the middle part of the heat roller 32. Electric power is supplied to these heaters, whereby both halogen lamps 34 and 35 are heated.

The unit 31 incorporates a sheet sensor 36 and a temperature sensor 37. The sheet sensor 36 moves as the fixing equipment 30 operates. The temperature sensor 37 detects the temperature of the heat roller 32. Although not shown, a drive section is provided to drive the heat roller 32 and the pressure roller 33. To apply a power-supply voltage to the drive section, the sheet sensor 36 and the temperature sensor 37, a power supply circuit is provided.

FIG. 3 is a view schematically showing a relationship between the image forming apparatus 10 and a removable unit. In the following description, the image forming apparatus 10 will be called “housing 10,” and the unit 31 of the fixing equipment 30 will referred to as a representative example of the removable unit. Nevertheless, any other unit may be the removable unit in the present invention.

As may be seen from FIG. 3, the unit 31 of the fixing equipment 30 can be removed from, and inserted into, the housing 10, while a cover 38 provided on the housing 10 stays open. Once set in the housing 10, the unit 31 operates to fix toner images. A switch 39 can detect the opening and closing of the cover 38. When the unit 31 is set at a specific position in the housing 10, connectors 50 and 51 electrically connect the fixing equipment 30 to the housing 10. Various power-supply voltages are then applied from the housing 10 to the fixing equipment 30. The fixing equipment 30 supplies various detection signals to the housing 10.

A loop harness 52 is connected at both ends to the ends of the connector 50. When the connectors 50 and 51 contact each other, voltage V is applied from the power supply to a terminal 53 through the loop harness 52. If the connector 50 is half inserted into the fixing equipment 30 and inevitably not electrically connected to the connector 51, the path extending from the loop harness 52 to the terminal 53 is cut, and no voltage is attained at the terminal 53. Thus, from the voltage at the terminal 53, it can be determined whether the unit 31 is set in the housing 10 in a desirable state.

The connectors 50 and 51 compose a first detecting means for detecting the setting state of the fixing equipment 30. The switch 39 composes a second detecting means for detecting opened/closed state of the cover 38.

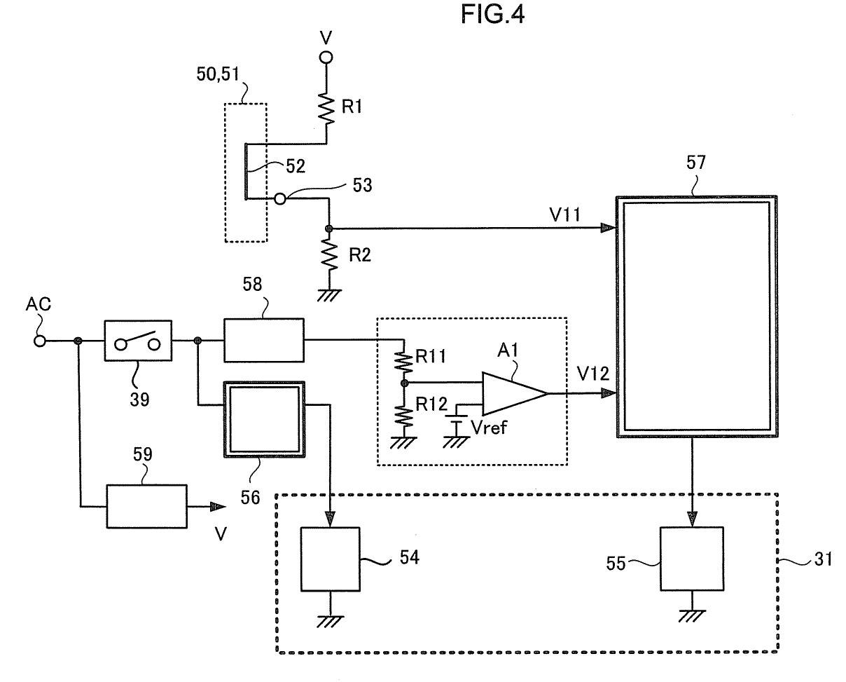

FIG. 4 is a block diagram showing the power supply circuit provided for the unit 31. The unit 31 incorporates a main load circuit 54. The main load circuit 54 comprises a drive circuit and a heater drive circuit. The drive circuit drives the heat roller 32 and the pressure roller 33. The heater drive circuit drives the halogen lamps 34 and 35. The unit 31 incorporates an accessory circuit 55, too. The accessory circuit 55 composes an accessory means. The accessory circuit 55 comprises the sheet sensor 36, temperature sensor 37, and a memory. A first control circuit 56 and a second control circuit 57 are provided. The first control circuit 56 controls the supply of power to the main load circuit 54. The second control circuit 57 controls the supply of power to the accessory circuit 55.

The switch 39 can connect the first control circuit 56 to an AC power supply (AC). The AC power supply (AC) can be connected by the switch 39 to a rectifying circuit 58. The rectifying circuit 58 is configured to convert AC voltage to DC voltage. The AC power supply (AC) is connected to another rectifying circuit 59. Like the circuit 58, the rectifying circuit 59 is designed to convert AC voltage to DC voltage, thereby to generate power-supply voltage V.

Resistors R11 and R12 divide the output voltage of the rectifying circuit 58, providing a divided voltage. The divided voltage is applied to a comparator A1. The comparator A1 compares the divided voltage with a reference voltage Vref. As a result, a voltage V12 is obtained at the output terminal of the comparator A1. This voltage V12 changes as the switch 39 is turned and off. Hence, from the voltage V12, it can be determined whether the cover 38 is opened or closed. For example, the voltage V12 is at low level when the switch 39 is on.

Whether the unit 31 is set or not is determined by using the loop harness 52. That is, the setting state of the unit 31 is detected from the changes in voltage V11 at the terminal 53. Instead of the loop harness 52, a micro-switch or the like may be used to detect the setting state of the unit 31.

The first control circuit 56 is a drive circuit that supplies an AC current to the heater of the main load circuit 54 as long as the switch 39 remains on. In other words, the circuit 56 controls the supply of power to the main load circuit 54, in accordance with whether the cover 38 is opened or closed. On the other hand, the second control circuit 57 controls the supply of power to the accessory circuit 55, in accordance with whether the connectors 50 and 51 are connected and whether the switch 39 is on or off.

That is, using the signal showing the setting state of the unit 31 and the signal showing whether the cover 38 is opened or closed, the second control circuit 57 supplies the power-supply voltage to the accessory circuit 55 no matter whether the cover 38 is opened or not, if it is determined that the unit 31 is set in the housing 10, and stops the application of the power-supply voltage to the accessory circuit 55 if the unit 31 is half inserted and not completely set in the housing 10 and if the cover 38 is opened.

Hence, the first control circuit 56 and the second control circuit 57 compose a control means for controlling the supply of power to the unit 31. Further, the first control circuit 56 composes a first control means for controlling the application of the operating voltage to the main load circuit 54 in accordance with whether the cover 38 is opened or closed. The second control circuit 57 composes second control means for controlling the application of the operating voltage to the accessory circuit 55 in accordance with whether the unit 31 is appropriately set and whether the cover 38 is opened or closed.

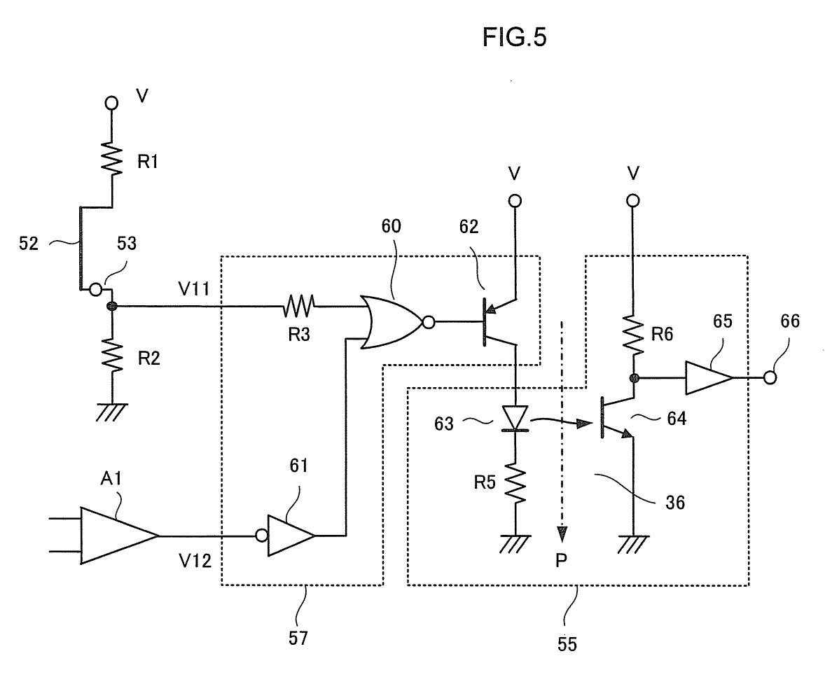

FIG. 5 is a circuit diagram showing specific examples of the second control circuit 57 and accessory circuit 55. In FIG. 5, the sheet sensor 36 is shown as accessory circuit 55.

In FIG. 5, the loop harness 52 is shown, which detects the setting state of the fixing equipment 30. While the unit 31 remains set in the housing 10, the power-supply voltage V (e.g., +5 V) is applied through a resistor R1 and the loop harness 52 to the terminal 53. The terminal 53 is connected to the ground (i.e., reference potential point) by a resistor R2.

The terminal 53 is connected by a resistor R3 to one input terminal of a NOR circuit 60. The output terminal of the comparator A1 shown in FIG. 4 is connected by an inverter 61 to the other input terminal of the NOR circuit 60. The output terminal of the NOR circuit 60 is connected to the base of a transistor 62. The emitter of the transistor 62 is connected to receive the power-supply voltage V.

The collector of the transistor 62 is connected to the sheet sensor 36 that is used as accessory circuit 55. The sheet sensor 36 has a photodiode 63 and a phototransistor 64. The photodiode 63 is connected to the collector of the transistor 62. The phototransistor 64 receives, at its base, the light emitted from the photodiode 63. The paper sheet P is transported, passing through the gap between the photodiode 63 and the phototransistor 64.

The cathode of the photodiode 63 is connected to the ground by a resistor R5. The power-supply voltage V is applied via a resistor R6 to the collector of the phototransistor 64. The collector of the phototransistor 64 is connected by an amplifier 65 to an output terminal 66. The emitter of the phototransistor 64 is connected to the ground.

If no paper sheets exist between the photodiode 63 and the phototransistor 64, the light emitted from the photodiode 63 reaches the phototransistor 64. If a paper sheet lies between the photodiode 63 and the phototransistor 64, the light emitted from the photodiode 63 does not reach the phototransistor 64.

Therefore, a signal showing whether the paper sheet P exists can be obtained at the output terminal 66. This signal is information representing the state in the unit 31. Using this information, various messages can be displayed on the display section 12. Thus, the display section 12 composes a message displaying means.

How the circuit of FIG. 5 operates will be explained.

If the unit 31 of the fixing equipment is set in the housing 10 in normal state, a voltage V11 develops across the resistor R2. The terminal 53 is therefore set to high level “H.” One input to the NOR circuit 60 is therefore “H.” The ratio of partial potentials generated by the resistors R1 and R2 is set to a value that the input to the NOR circuit 60 is “H” when the terminal 53 rises to high level “H.”

As long as the cover 38 remains closed, the switch 39 is turned on. In this case, the output voltage V12 of the comparator A1 is at low level “L,” and the input to the inverter 61 is at low level “L,” too. The output of the inverter 61 therefore rises to “H.” Hence, the other input to the NOR circuit 60 is “H,” and the output terminal of the NOR circuit 60 is at low level “L.”

As a result, the transistor 62 is turned on. A current therefore flows in the emitter-collector path (main conduction path) of the transistor 62. The sheet sensor 36 is thereby activated. The light emitted from the photodiode 63 is applied to the base of the phototransistor 64. The phototransistor 64 is therefore turned on or off in accordance with whether a paper sheet P exists between the photodiode 63 and the phototransistor 64. A detection signal indicating the presence or absence of a paper sheet is obtained at the output terminal 66.

When the cover 38 is opened, the switch 39 is turned off. As a result, the output of the comparator A1 and the input to the inverter 61 are “H,” and the output of the inverter 61 is “L.” Therefore, the other input to the NOR circuit 60 becomes “L.” Nonetheless, the output of the NOR circuit 60 remains “L” because one input to the NOR circuit 60 stays at high level “H.” The transistor 62 is turned on, whereby the sheet sensor 36 stays in an activated state.

At this time, the supply of power to the main load circuit 54 via the first control circuit 56 is interrupted as shown in FIG. 4. The drive section for the rollers and the drive circuit for the heaters of the fixing equipment 30 are therefore stopped. Nevertheless, the display section 12 can display a message showing that jamming, if any, is occurring in the fixing equipment 30, because the sheet sensor 36 is still activated.

The unit 31 may be incompletely set in the housing 10 while the cover 38 remains opened. In this case, a current is no longer supplied from the loop harness 52. No voltage therefore develops at the terminal 53. As a result, one input to the NOR circuit 60 falls to low level “L.” Thus, both inputs to the NOR circuit 60 are “L,” and the output of the NOR circuit 60 is “H.”

Therefore, the transistor 62 is turned off, whereby the sheet sensor 36 stops operating. The sheet sensor 36 also stops operating when the unit 31 is removed from the housing 10.

As described above, in the image forming apparatus according to this embodiment, the fixing equipment 30 takes the normal state and the sheet sensor 36 normally operates, as long as the unit 31 remains set in the housing 10 and the cover 38 remains closed. When the cover 38 is opened, the fixing equipment 30 stops operating. Nevertheless, the sheet sensor 36 keeps operating because the power-supply voltage is applied to the accessory circuit 55 provided in the unit 31.

Therefore, any paper sheet that lies between the photodiode 63 and the phototransistor 64 can be detected, and this fact can be shown on the display section 12. In addition, the display section 12 can display a message, telling the user to replace the unit 31 with another. When the unit 31 is removed completely, the supply of power to the unit 31 is stopped.

In the example described above, the sheet sensor 36 is the accessory circuit 55. Instead, the accessory circuit 55 may instead be the temperature sensor 37 that detects the temperature in the unit 31 or the memory (not shown) that is provided to store the information acquired while the image forming apparatus is operating.

In the example described above, the fixing equipment 30 is the exchangeable unit. Instead, any other equipment can be the exchangeable unit. For example, the photosensitive drum 22, charger 23, developing equipment 24, cleaner 26, toner recovery section 27 and toner cartridge 28 (all shown in FIG. 1) may be provided as a single process unit 200, which can be removably provided in the housing 10.

If this is the case, the process unit 200 incorporates a sheet sensor 201. This sheet sensor 201 can detect the state in which the paper sheet P is being transported and jamming, if any, occurring.

The sheet sensor 201 is constituted by, for example, a light-emitting diode and a phototransistor. The light-emitting diode emits light toward a paper sheet P. The phototransistor receives the light reflected from the paper sheet P. The sheet sensor 201 can thus detect the paper sheet P.

Therefore, it suffices to arrange the drive section for the photosensitive drum 22 of the process unit 200 in the main load circuit 54, and arrange the drive section for the sheet sensor 201 in the accessory circuit 55.

Alternatively, the developing equipment 24 may be the exchangeable unit. In this case, the drive section for the developing roller of the developing equipment 24 is arranged in the main load circuit 54, and the toner-amount detecting section 202 provided in the developing equipment 24 is arranged in the accessory circuit 55.

Moreover, the image forming apparatus may not be the printer section 20. It may instead be an image forming apparatus that has an intermediate transfer belt that is driven around, wrapped around a driving roller and a driven roller. This image forming apparatus has, besides the intermediate transfer belt, four image forming sections which are arranged side by side in the direction of driving the intermediate transfer belt and which form a yellow (Y) image, a magenta (M) image, a cyan (C) image and a black (K) image, respectively.

The image forming sections have a photoconductor each. In each image forming section, a charger, a developing equipment, a cleaner and the like are arranged around the photosensitive drum. Primary transfer rollers are arranged, contacting the photosensitive drums and the intermediate transfer belt. The primary transfer rollers transfer toner images from the drums to the intermediate transfer belt. Further, secondary transfer rollers are arranged, contacting the intermediate transfer belt, for transferring toner images from the intermediate transfer belt to a paper sheet.

In the image forming apparatus having an intermediate transfer belt, the mechanism including the intermediate transfer belt and the primary transfer rollers compose a transfer unit. The transfer unit is removably provided in the housing. The image forming apparatus further has a sensor that detects whether paper sheets stick to the intermediate transfer belt after images have been transferred to them from the secondary transfer rollers.

Therefore, it suffices to provide the drive section for the intermediate transfer belt in the main load circuit 54, and the sensor for detecting paper sheets sticking to the intermediate transfer belt in the accessory circuit 55.

As has been described, in the image forming apparatus according to the present embodiment, the supply of power to the drive circuits and the like provided in the unit is stopped, but the supply of power to circuits such as sensors is not stopped, when the cover is opened. This is because the sensors must operate even while the cover remains opened. Therefore, necessary information can be acquired. When the removable unit is completely removed from the housing, the supply of power to the unit is stopped. This helps to secure safety.

The present invention is not limited to the embodiment described above. Various modification scan be made without departing from the scope of the invention as described in the following claims.

Although exemplary embodiments of the present invention have been shown and described, it will be apparent to those having ordinary skill in the art that a number of changes, modifications, or alterations to the invention as described herein may be made, none of which from the spirit of the present invention. All such changes, modifications, and alterations should therefore be seen as within the scope of the present invention.

What is claimed is:

1. An image forming apparatus comprising:
a housing;
a unit removably provided in the housing and configured to perform a specific operation in cooperation with components provided in the housing while being provided in the housing;
an accessory circuit, included in the unit, which operates as the unit performs a specific operation;
a cover which covers the unit provided in the housing;
a first detector which detects a state in which the unit is set in the housing;
a second detector which detects whether the cover is opened or closed; and
a control section which controls the supply of power to the unit in accordance with the results of detection by the first and second detectors,
wherein the control section applies an operating voltage to the entire unit while the unit remains set in the housing and the cover remains closed, applies the operating voltage to the accessory circuit while the unit remains set in the housing and the cover remains opened, and stops the application of the operating voltage to the entire unit when the unit is removed from the housing.

2. The image forming apparatus according to claim 1, wherein the accessory circuit includes a memory or a sensor which detects an internal state of the unit.

3. The image forming apparatus according to claim 1, wherein the first detector comprises a pair of connectors configured to connect the housing and the unit electrically and a loop harness provided on the connector secured to the unit.

4. The image forming apparatus according to claim 1, wherein the second detector comprises a switch which operates as the cover is opened and closed.

5. The image forming apparatus according to claim 1, wherein an image forming section which forms a toner image on a paper sheet is provided in the housing, the unit is a fixing unit configured to fix the toner image on the paper sheet, and the accessory circuit includes a sensor configured to detect presence or absence of a paper sheet in the fixing unit or the temperature in the fixing unit.

6. The image forming apparatus according to claim 1, wherein an image forming section which forms a toner image on a paper sheet is provided in the housing, the unit is a process unit including a photosensitive drum and a developing equipment, and the accessory circuit includes a sensor configured to detect presence or absence of a paper sheet in the process unit or an amount of toner remaining in the process unit.

7. The image forming apparatus according to claim 1, wherein an image forming section which forms a toner image on a paper sheet is provided in the housing, the unit is a transfer unit including a transfer belt and a transfer roller, and the accessory circuit includes a sensor configured to detect a paper sheet sticking to the transfer belt.

8. The image forming apparatus according to claim 1, wherein an image forming section which forms a toner image on a paper sheet is provided in the housing, the unit is a developing unit, and the accessory circuit includes a sensor configured to detect an amount of toner remaining in the developing unit.

9. The image forming apparatus according to claim 1, wherein the control section comprises:
a first control circuit that controls application of an operating voltage to a drive section for driving the unit, in accordance with the result of detection by the second detector; and
a second control circuit that controls application of an operating voltage to the accessory circuit in accordance with the results of detection by the first and second detectors.

10. The image forming apparatus according to claim 9, wherein the second control circuit has a logic circuit connected to receive detection outputs from the first and second detectors, and a transistor having a control electrode, a main conduction path connected between a power supply and the accessory circuit, the control electrode configured to be controlled by an output from the logic circuit, and the application of operating voltage to the accessory circuit is controlled in accordance with the conducting state of the transistor.

11. The image forming apparatus according to claim 10, further comprising a display section which displays messages by using the result of operation of the accessory circuit.

12. An image forming apparatus having a housing and a unit removably provided in the housing and configured to perform a specific operation in cooperation with components provided in the housing while being provided in the housing, said apparatus comprising:
accessory means included in the unit, which operates as the unit performs the specific operation;
first detecting means for detecting a state in which the unit is set in the housing;
second detecting means for detecting whether a cover provided for the unit is opened or closed; and
control means for controlling the supply of power to the unit in accordance with the results of detection by the first and second detecting means,
wherein the control means applies an operating voltage to the entire unit while the unit remains set in the housing and the cover remains closed, applies the operating voltage to the accessory means while the unit remains set in the housing and the cover remains opened, and stops the application of the operating voltage to the entire unit when the unit is removed from the housing.

13. The image forming apparatus according to claim 12, wherein the accessory means includes a memory or a sensor that detects an internal state of the unit.

14. The image forming apparatus according to claim 12, wherein the first detecting means comprises a pair of connectors configured to connect the housing and the unit electrically and a loop harness provided on the connector secured to the unit.

15. The image forming apparatus according to claim 12, wherein the second detecting means comprises a switch which operates as the cover is opened and closed.

16. The image forming apparatus according to claim 12, wherein the control means comprises:
first control means for controlling application of an operating voltage to a drive section for driving the unit, in accordance with the result of detection by the second detecting means; and
second control means for controlling application of an operating voltage to the accessory means in accordance with the results of detection by the first and second detecting means.

17. The image forming apparatus according to claim 16, wherein the second control means has a logic circuit connected to receive detection outputs from the first and second detecting means, and a transistor having a control electrode, a main conduction path connected between a power supply and the accessory means, the control electrode configured to be controlled by an output from the logic circuit, and the application of operating voltage to the accessory means is controlled in accordance with the conducting state of the transistor.

18. The image forming apparatus according to claim 17, further comprising display means for displaying messages by using the result of operation of the accessory means.

19. A method of controlling an image forming apparatus, comprising:
setting a unit in a housing of the image forming apparatus, the unit configured to perform a specific operation in cooperation with components provided in the housing;
activating an accessory circuit included in the unit, as the unit performs the specific operation;
detecting a state in which the unit is set in the housing;
detecting whether a cover provided on the housing is opened or closed;
controlling the supply of power to the unit in accordance with a state in which the unit is set in the housing and whether the cover is opened or closed;
applying an operating voltage to the entire unit while the unit remains set in the housing and the cover remains closed;
applying the operating voltage to the accessory circuit while the unit remains set in the housing and the cover remains opened; and
stopping the application of the operating voltage to the entire unit when the unit is removed from the housing.

20. The method of controlling an image forming apparatus, according to claim 19, wherein the accessory circuit includes a sensor configured to detect an internal state of the unit, and messages are displayed by using the result of detection made by the sensor.
